(19) United States
(12) Patent Application Publication
(10) Pub. No.: US 2026/0210454 A1
(43) Pub. Date: Jul. 23, 2026

(54) PLUG VALVE

(71) Applicant: SANDONG METAL INDUSTRY, Gumi-si (KR)

(72) Inventor: Suk Soo CHANG, Daegu (KR)

(73) Assignee: SANDONG METAL INDUSTRY, Gumi-si (KR)

(21) Appl. No.: 19/045,369

(22) Filed: Feb. 4, 2025

(30) Foreign Application Priority Data
Jan. 20, 2025 (KR) 10-2025-0007774

(51) Int. Cl. F16K 27/06; F16K 5/04

(52) U.S. Cl. CPC F16K 27/065; F16K 5/0471; F16K 5/0492

(57) ABSTRACT

A plug valve may include a body having a flow path formed therethrough to allow fluid to pass, a plug rotatably inserted into an interior of the body and having a through hole that selectively connects to the flow path through rotation, an insert provided between the body and the plug, and a body cap mounted on a lower portion of the body by fastening of bolts and supporting the plug and the insert.

### CROSS-REFERENCE TO RELATED APPLICATION

This application claims the priority benefit of Korean Patent Application No. 10-2025-0007774 filed on Jan. 20, 2025, and all the benefits accruing therefrom under 35 U.S.C. § 119, the contents of which are incorporated by reference in their entirety.

### BACKGROUND

The present invention relates to a plug valve, and more specifically, to a plug valve for controlling the flow of a fluid by rotating a plug.

In general, a valve may be provided on a flow path and control a flow rate, a flow direction, and the like of a fluid.

There are various types of valves, and among them, a plug valve may open or close a flow path by rotating a plug in a body thereof.

According to the conventional technology, a plug valve may include a body, a plug, an insert, an adjustment nut, and a handle.

Since the adjustment nut includes a male screw on an outer surface thereof and the body includes a female screw on a lower inner surface, the adjustment nut is coupled to the body in a screw fastening manner. In order for the adjustment nut to be coupled to the body at a correct location, a location of the adjustment nut should be additionally finely adjusted after the adjustment nut is coupled to the body. Accordingly, it is difficult to couple the adjustment nut to the body at the correct location.

In addition, a rotation angle of the plug is adjusted using a stopper provided between the body and the handle and a stopper bolt disposed on an upper surface of the body. Since the stopper and the stopper bolt are externally exposed, the stopper and the stopper bolt can be damaged by an external impact or corroded by a fluid.

### PRIOR ART DOCUMENT

### Patent Document

(Patent Document 0001) (0001) Korean Registered Patent No. 10-2395423 (Registered on May 3, 2022)

(Patent Document 0002) (0002) Korean Registered Patent No. 10-1930393 (Registered on Dec. 12, 2018)

### SUMMARY

The present invention is directed to providing a plug valve in which a member for covering a lower surface of a body is easily mounted and a unit for adjusting a rotation angle of a plug is prevented from being damaged.

According to an aspect of the present invention, there is provided a plug valve including a body having a flow path formed therethrough to allow fluid to pass, a plug rotatably inserted into an interior of the body and having a through hole that selectively connects to the flow path through rotation, an insert provided between the body and the plug, and a body cap mounted on a lower portion of the body by fastening of bolts and supporting the plug and the insert.

According to embodiments the present invention, the plug valve may further include an insert pin of which a lower end is fixedly fitted into an upper surface of the body cap and an upper end presses a lower surface of the insert to bring the insert into close contact with the body and which prevents the insert from rotating when the plug rotates.

According to embodiments the present invention, an insert pin hole may be provided in the lower surface of the insert, and the upper end of the insert pin may be inserted into the insert pin hole.

According to embodiments the present invention, the plug valve may further include a stop pin protruding from a lower surface of the plug and an arc-shaped accommodation groove which is formed in an upper surface of the body cap to accommodate the stop pin and limits a rotation angle of the plug by limiting a movement range of the stop pin.

According to embodiments the present invention, the plug valve may further include an alignment pin of which a lower end is fixedly fitted into an upper surface of the body cap and an upper end is fitted into a fitting groove provided in a lower surface of the body or of which the upper end is fixedly fitted into the lower surface of the body and the lower end is fitted into a fitting groove provided in the upper surface of the body cap, wherein bolt fastening holes provided in the lower surface of the body may be aligned with through holes provided to vertically pass through the body cap using the alignment pin before the bolts are fastened.

According to embodiments the present invention, the plug valve may further include a tap hole provided at a location corresponding to a lower surface of the body to pass through the body cap, wherein after removing the bolts, a separation bolt is fastened into the tap hole to press against the lower surface of the body, thereby separating the body from the body cap.

According to the present invention, the body cap may be mounted on the lower portion of the body by fastening bolts. Accordingly, the body cap may be conveniently mounted on the body, and there is no need to finely adjust the location of the body cap.

In addition, since the stop pin and the accommodation groove are located between the lower surface of the plug and the upper surface of the body cap, the stop pin and the accommodation groove may be prevented from being externally exposed. Accordingly, the stop pin and the accommodation groove may be prevented from being damaged by an external impact or contaminated by foreign matter.

In addition, since the insert pin is provided, the insert can be prevented from being rotated when the plug rotates.

### BRIEF DESCRIPTION OF THE DRAWINGS

FIG. 1 is a perspective view for describing a plug valve according to one embodiment of the present invention;

FIG. 2 is a cross-sectional view along line A-A illustrated in FIG. 1;

FIG. 3 is a cross-sectional view for describing a body in FIG. 2;

FIG. 4 is a perspective view for describing an insert according to one embodiment of the present invention;

FIG. 5 is a perspective view for describing a body cap according to one embodiment of the present invention; and

FIG. 6 is a plan view for describing the body cap illustrated in FIG. 5.

### DETAILED DESCRIPTION

Hereinafter, the present invention will be described in detail with reference to the accompanying drawings. While the present invention may be modified in various ways and have various alternative forms, specific embodiments thereof will be illustrated in the drawings and described in detail below. However, there is no intent to limit the present invention to the specific embodiments, and it should be understood that the present invention covers all modifications, equivalents, and alternatives falling within the range of the spirit and scope of the present invention. When the present invention is described with reference to the accompanying drawings, like numbers refer to like components. In the accompanying drawings, sizes of structures are greater than those of actual structures for clarity of the present invention.

Although terms such as “first,” “second,” and the like may be used to describe various components, the components are not limited by these terms. These terms are only used to distinguish one component from another component. Accordingly, a first component may be named a second component, and similarly, a second component may also be named a first component without departing from the scope of the present invention.

Terms used herein are only for the purpose of describing particular embodiments and are not intended to limit the present invention. Singular forms are intended to include the plural forms, unless the context clearly indicates otherwise. In the present specification, it should be understood that the terms “comprise” or “include” used herein specify the presence of stated features, numbers, steps, operations, elements, components, or combinations thereof but do not preclude the presence or addition of one or more other features, numbers, steps, operations, elements, components, or combinations thereof.

Unless otherwise defined, all terms including technical and scientific terms used herein have meanings which are the same as meanings generally understood by those skilled in the art. Terms, such as those defined in commonly used dictionaries, should be interpreted as having meanings that are consistent with their meanings in the context of the relevant art and will not be interpreted in an idealized or overly formal sense unless expressly so defined here.

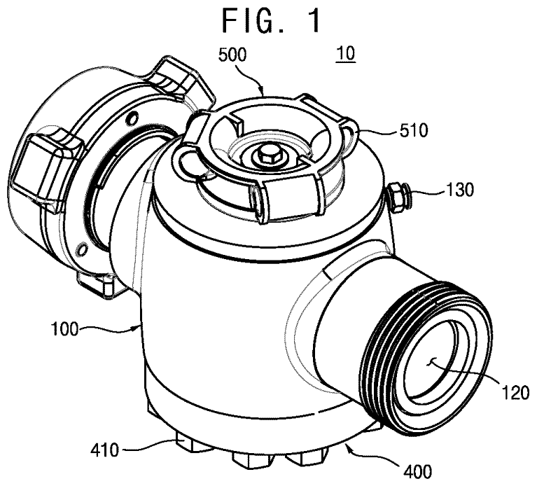

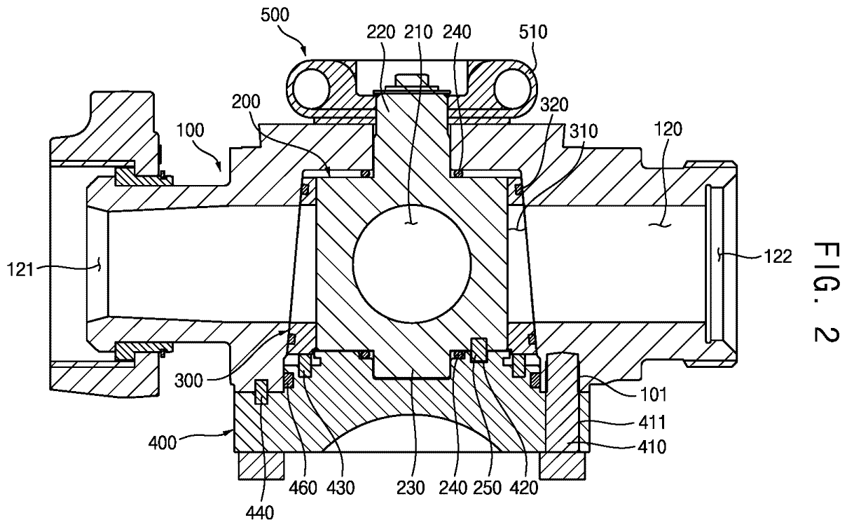

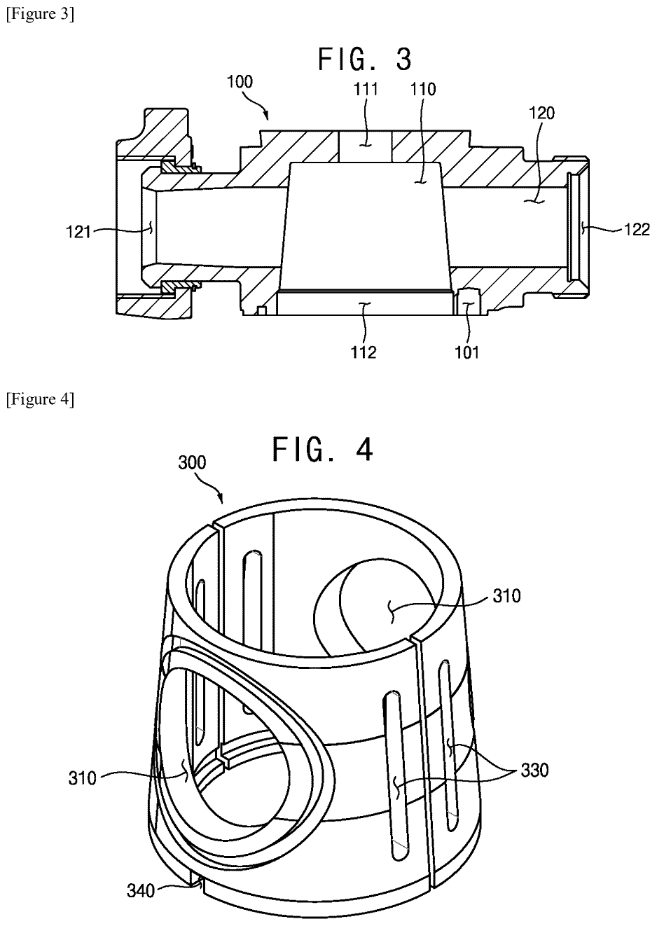

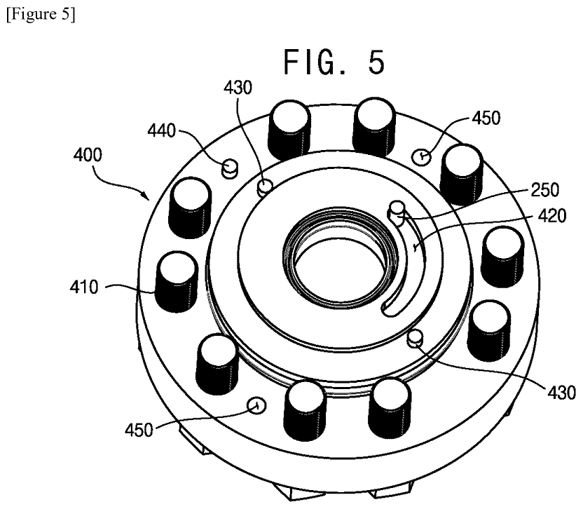

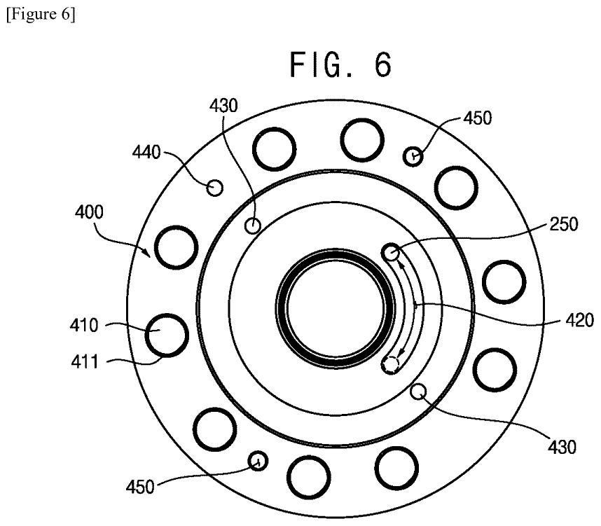

FIG. 1 is a perspective view for describing a plug valve according to one embodiment of the present invention, and FIG. 2 is a cross-sectional view along line A-A illustrated in FIG. 1. FIG. 3 is a cross-sectional view for describing a body in FIG. 2, and FIG. 4 is a perspective view for describing an insert according to one embodiment of the present invention. FIG. 5 is a perspective view for describing a body cap according to one embodiment of the present invention, and FIG. 6 is a plan view for describing the body cap illustrated in FIG. 5.

Referring to FIGS. 1 to 6, a plug valve 10 according to one embodiment of the present invention may include a body 100, a plug 200, an insert 300, a body cap 400, and a handle 500. The body 100 may maintain and support another component of the plug valve 10 and may be connected to a pipe (not shown) and the like to allow a fluid to pass therethrough.

According to one embodiment, the body 100 may include an internal space 110, a flow path 120, and an injection port 130.

The internal space 110 may be formed in a central portion of the body 100 and have a tapered inner circumferential surface of a shape having a narrow upper portion and a wide lower portion, of which an inner diameter increases toward the lower portion.

The plug 200 and the insert 300 may be disposed in the internal space 110.

The internal space 110 includes an upper opening 111 and a lower opening 112.

The upper opening 111 may be connected to the internal space 110 and may pass through an upper surface of the body 100.

An upper shaft 220 of the plug 200 protruding upward may be disposed in the upper opening 111.

The lower opening 112 may be connected to the internal space 110 and may pass through a lower surface of the body 100.

The body cap 400 may be disposed on the lower opening 112.

The flow path 120 may be formed to horizontally pass through the body 100. A fluid may pass through the flow path 120.

For example, the flow path 120 may include an inlet 121 and an outlet 122, a fluid supplied through the inlet 121 may pass through the internal space 110 and may be discharged through the outlet 122. In this case, a supply direction and a discharge direction of the fluid may be changed. Each of the inlet 121 and the outlet 122 may further include a flange and a male screw or a fastening nut for connection with the pipe.

The injection port 130 may be provided in one side of an outer surface of the body 100, and a lubricant may be injected into the internal space 110 through the injection port 130.

For example, an injection apparatus (not shown) may be inserted into the injection port 130, and a lubricant may be injected therethrough. The injection port 130 may be formed to pass through the body 100, and the injected lubricant may be supplied to the internal space 110.

According to one embodiment, the injection port 130 may be disposed in an upper portion of the body 100. Accordingly, the lubricant supplied through the injection port 130 may be widely dispersed inside the body 100 and outside the insert 300 while falling down.

In addition, the lubricant may also be supplied into a gap between the insert 300 and the plug 200. Accordingly, the lubricant supplied through the injection port 130 may allow the plug 200 rotatably provided in the internal space 110 to rotate smoothly when the plug 200 rotates. In addition, the fluid may be prevented from leaking through the gap between the plug 200 and the insert 300.

Since a structure for supplying the lubricant to the gap between the plug 200 and the insert 300 is similar to a structure for supplying a lubricant installed in a conventional body of a valve or bearing, drawings or descriptions of specific lubricant supply structures will be omitted.

The plug 200 may have a substantially cylindrical shape and may be provided in the body 100, that is, in the internal space 110. In addition, the plug 200 may rotate about a central axis in a vertical direction.

The plug 200 may include a through hole 210.

The through hole 210 may be formed to horizontally pass through the plug 200. As the plug 200 rotates, the through hole 210 may be selectively connected to the flow path 120.

For example, according to a rotation angle of the plug 200, the flow path 120 may be fully opened, partially opened, or closed.

The plug 200 may further include the upper shaft 220 and a lower shaft 230.

The upper shaft 220 may protrude from an upper surface of the plug 200. The upper shaft 220 may be inserted into the upper opening 111 and protrude upward from the body 100. The handle 500 may be connected to the upper shaft 220.

The lower shaft 230 may protrude from a lower surface of the plug 200. The lower shaft 230 may be rotatably supported by the body cap 400.

A plug seal 240 may be provided on an outer circumferential surface of the plug 200. The plug seal 240 may seal a gap between the body 100 and the plug 200. For example, the plug seal 240 may be provided on each of an outer circumferential surface of the upper shaft 220 and an outer circumferential surface of the lower shaft 230. An example of the plug seal 240 may be an O-ring.

The insert 300 may be provided between the body 100 and the plug 200.

Specifically, the insert 300 may be disposed in the internal space 110 of the body 100 and may cover an outer surface of the plug 200. The insert 300 may remain in contact with the body 100 and/or the plug 200 or have a predetermined gap from the body 100 and/or the plug 200.

A shape of the insert 300 may not be specifically limited, and an inner circumferential surface of the insert 300 may correspond to the outer circumferential surface of the plug 200, and an outer circumferential surface of the insert 300 may correspond to the inner circumferential surface surrounding the internal space 110 of the body 100. According to one embodiment, the outer circumferential surface of the insert 300 may have a shape that is tapered at a predetermined angle.

According to one embodiment, the insert 300 may be divided into a plurality of portions. The insert 300 may include a pair of connection holes 310.

The connection holes 310 may be formed to horizontally pass through the insert 300 and disposed to be connected to the inlet 121 and the outlet 122.

Accordingly, a fluid introduced into the plug valve 10 may pass through the inlet 121, the connection hole 310, and the through hole 210 and may be discharged to the outside through the connection hole 310 and the outlet 122.

Insert seals 320 may be provided on the outer circumferential surface of the insert 300. The insert seals 320 may be disposed along circumferences of the connection holes 310. An example of each of the insert seals 320 may be an O-ring.

The insert seal 320 may seal the gap between the body 100 and the insert 300 to prevent a fluid or lubricant from leaking through a gap between the inner circumferential surface of the internal space 110 and the outer circumferential surface of the insert 300.

The insert 300 may include a lubricant hole 330. As an example, the lubricant hole 330 may be formed to horizontally pass through the insert 300, that is, pass from the outer circumferential surface to the inner circumferential surface of the insert 300. Accordingly, the lubricant introduced along the outer circumferential surface of the insert 300 may be introduced into an interior of the insert 300 through the lubricant hole 330. The introduced lubricant may lubricate the outer circumferential surface of the plug 200 and the inner circumferential surface of the insert 300.

The body cap 400 may be mounted on a lower portion of the body 100 by fastening bolts 410 and may support the plug 200 and the insert 300.

Specifically, the body cap 400 may include a plurality of through holes 411 vertically passing therethrough along a perimeter thereof, and the body 100 may include a plurality of bolt fastening holes 101 in the lower surface of the body 100 to correspond to the through holes 411.

The bolts 410 may be inserted into the through holes 411 and fastened to the bolt fastening holes 101 so that the body cap 400 may be mounted on the lower portion of the body 100. Accordingly, the body cap 400 may be conveniently mounted on the body 100.

In addition, since the body cap 400 may be accurately mounted on the lower portion of the body 100 by simply fastening the bolts 410, there is no need to finely adjust a location of the body cap 400 based on the body 100.

When the body cap 400 is mounted on the lower portion of the body 100, a portion of the body cap 400 may be inserted into the lower opening 112 to close the lower opening 112. In addition, the body cap 400 may accommodate the lower shaft 230 of the plug 200 and support the plug 200 to enable stable rotation of the plug 200.

The plug valve 10 may further include a stop pin 250 and an accommodation groove 420.

The stop pin 250 may be provided to protrude from the lower surface of the plug 200. The stop pin 250 may rotate along with the plug 200.

The accommodation groove 420 may be provided in an upper surface of the body cap 400 at a location corresponding to the stop pin 250 and accommodate the stop pin 250. The accommodation groove 420 may have an arc shape, and the stop pin 250 may move along the accommodation groove 420 when the plug 200 rotates. In this case, since the stop pin 250 is blocked by both ends of the accommodation groove 420, the stop pin 250 may move a distance corresponding to a length of the accommodation groove 420. Accordingly, the accommodation groove 420 may limit a movement range of the stop pin 250. As the movement range of the stop pin 250 is limited, a rotation angle of the plug 200 may be limited.

As an example, positions at which the stop pin 250 is blocked by the accommodation groove 420 may correspond to a position at which the plug valve 10 is fully opened and a position at which the plug valve 10 is completely closed.

As an example, the length of the accommodation groove 420 may be a ¼ of a circumferential length of the body cap 400, and a rotation angle of the plug 200 may be 90°.

Meanwhile, although not illustrated in the drawings, the stop pin 250 may be provided on the upper surface of the body cap 400, and the accommodation groove 420 may be provided in the lower surface of the plug 200.

As the stop pin 250 and the accommodation groove 420 are located on the lower surface of the plug 200 and the upper surface of the body cap 400, respectively, the stop pin 250 and the accommodation groove 420 may be prevented from being externally exposed. Accordingly, the stop pin 250 and the accommodation groove 420 may be prevented from being damaged by an external impact or contaminated by foreign matter.

The plug valve 10 may further include an insert pin 430.

A lower end of the insert pin 430 may be fixedly fitted into the upper surface of the body cap 400, and an upper end of the insert pin 430 may protrude from the upper surface of the body cap 400. The upper end of the insert pin 430 may press a lower surface of the insert 300 while the body cap 400 is mounted on the lower surface of the body 100. The insert 300 may be pushed upward by pressing the insert pin 430, and the insert 300 may be in close contact with the body 100.

In addition, the upper end of the insert pin 430 may press the lower surface of the insert 300 to fix the insert 300. Accordingly, the insert 300 may be prevented from rotating when the plug 200 rotates.

Meanwhile, in order to stably press the insert 300, the insert pin 430 may be provided as a plurality of insert pins 430, and the plurality of insert pins 430 may be spaced apart from each other at equiangular intervals.

In addition, an insert pin hole 340 may be provided in the lower surface of the insert 300, and the upper end of the insert pin 430 may also be inserted into the insert pin hole 340. Accordingly, the insert pin 430 may fix the insert 300 to prevent the insert 300 from rotating.

The plug valve 10 may further include an alignment pin 440.

A lower end of the alignment pin 440 may be fixedly fitted into the upper surface of the body cap 400, and an upper end of the alignment pin 440 may be fitted into a fitting groove provided in the lower surface of the body 100. Alternatively, the upper end of the alignment pin 440 may be fixedly fitted into the lower surface of the body 100, and the lower end thereof may be fitted into a fitting groove provided in the upper surface of the body cap 400.

Before the bolts 410 are fastened, in a state in which the body cap 400 supports the lower shaft 230, the body cap 400 may be rotated to align the bolt fastening holes 101 with the through holes 411 using the alignment pin 440.

Since the bolt fastening holes 101 are aligned with the through holes 411, the bolts 410 may be easily fastened to the body cap 400 and the body 100.

When the bolt fastening holes 101 are aligned with the through holes 411 using the alignment pin 440, the stop pin 250 may be aligned with the accommodation groove 420 so that the stop pin 250 is accommodated in the accommodation groove 420.

The plug valve 10 may further include a tap hole 450.

The tap hole 450 may be provided to pass through the body cap 400 at a location corresponding to the lower surface of the body 100. The tap hole 450 is a hole of which an inner surface is provided with a screw.

As an example, the tap hole 450 may be provided as a plurality of tap holes 450, and the plurality of tap holes 450 may be disposed apart from each other.

Even after the bolts 410 are removed, when the body cap 400 is not separated from the body 100, as an additional separation bolt is fastened and tightened to the tap hole 450, the separation bolt may press the lower surface of the body 100. Accordingly, the body 100 and the body cap 400 may be easily separated.

A body cap seal 460 may be provided on an outer circumferential surface of the body cap 400. Specifically, the body cap seal 460 may be provided on an outer circumferential surface of a portion of the body cap 400 inserted into the lower opening 112. An example of the body cap seal 460 may be an O-ring.

The body cap seal 460 may seal a gap between the body 100 and the body cap 400 to prevent the fluid or lubricant from leaking through the gap between the body 100 and the body cap 400.

The handle 500 may be coupled to the upper shaft 220 of the plug 200 protruding upward from the body 100. The plug 200 may be easily rotated using the handle 500.

The handle 500 may include a connector 510.

At least one or more connectors 510 may be disposed at one side of the handle 500, and each of the connectors 510 may have a hole or bore shape. A user may insert a rod or the like into the connector 510 and more easily rotate the handle 500.

While the present invention has been described above with reference to exemplary embodiments, it may be understood by those skilled in the art that various modifications and changes of the present invention may be made within a range not departing from the spirit and scope of the present invention defined by the appended claims.

1. A plug valve comprising:
a body having a flow path formed therethrough to allow fluid to pass;
a plug rotatably inserted into an interior of the body and having a through hole that selectively connects to the flow path through rotation;
an insert provided between the body and the plug; and
a body cap mounted on a lower portion of the body by fastening of bolts and supporting the plug and the insert.

2. The plug valve of claim 1, further comprising an insert pin of which a lower end is fixedly fitted into an upper surface of the body cap and an upper end presses a lower surface of the insert to bring the insert into close contact with the body and which prevents the insert from rotating when the plug rotates.

3. The plug valve of claim 2, wherein:
an insert pin hole is provided in the lower surface of the insert; and
the upper end of the insert pin is inserted into the insert pin hole.

4. The plug valve of claim 1, further comprising:
a stop pin protruding from a lower surface of the plug; and
an arc-shaped accommodation groove which is formed in an upper surface of the body cap to accommodate the stop pin and limits a rotation angle of the plug by limiting a movement range of the stop pin.

5. The plug valve of claim 1, further comprising an alignment pin of which a lower end is fixedly fitted into an upper surface of the body cap and an upper end is fitted into a fitting groove provided in a lower surface of the body or of which the upper end is fixedly fitted into the lower surface of the body and the lower end is fitted into a fitting groove provided in the upper surface of the body cap,
wherein bolt fastening holes provided in the lower surface of the body are aligned with through holes provided to vertically pass through the body cap using the alignment pin before the bolts are fastened.

6. The plug valve of claim 1, further comprising a tap hole provided at a location corresponding to a lower surface of the body to pass through the body cap,
wherein after removing the bolts, a separation bolt is fastened into the tap hole to press against the lower surface of the body, thereby separating the body from the body cap.
